(19) United States
(12) Patent Application Publication
(10) Pub. No.: US 2010/0238691 A1
(43) Pub. Date: Sep. 23, 2010

(54) AC-TO-DC POWER SUPPLY CIRCUIT

(76) Inventor: Tsung-Ein Tsai, Taipei (TW)

Correspondence Address: Hershkovitz & Associates, LLC, 2845 Duke Street, Alexandria, VA, 22314, US

(21) Appl. No.: 12/496,628

(22) Filed: Jul. 1, 2009

(30) Foreign Application Priority Data
Mar. 23, 2009 (TW) 098204546
May 18, 2009 (TW) 098208582

(51) Int. Cl. H02M 7/06

(52) U.S. Cl. 363/126

(57) ABSTRACT

An AC-to-DC power supply circuit has an AC capacitor, a half-wave rectifier, and a filter capacitor. Through the AC capacitor, the half-wave rectifier forms a power supply circuit with an AC power supply for converting AC power to half-wave DC power. The filer circuit further converts the half-wave DC power into low-voltage DC power. The AC-to-DC power supply circuit adjusts the ratio of the AC capacitor and the filter capacitor so that the capacitance ratio matches with the voltage ratio of the half-wave DC power and the lower-voltage DC power. As a consequence, the AC-to-DC power supply circuit does not need to use a large-size transformer and can still effectively convert AC power to low-voltage DC power. This can largely reduce the manufacturing cost.

### BACKGROUND OF THE INVENTION

1. Field of the Invention

The invention relates to an AC-to-DC power supply circuit and, in particular, to a simplified AC-to-DC power supply circuit.

2. Description of Related Art

As shown in FIG. 5, current mobile phones, light emitting diode (LED) and laptop computers use a separate voltage-lowering power supply circuit 20 that includes a transformer 21 and a full-bridge rectifier 22.

The transformer 21 has a primary coil 211 and a secondary coil 212. The number of turns on the secondary coil 212 is smaller than that of the primary coil 211. The primary coil 211 connects to an AC power supply. Therefore, the secondary coil 212 of the transformer outputs low-voltage AC power.

The input terminal of the full-bridge rectifier 22 connects to the secondary coil 212 of the transformer 21. Its output terminal connects to a filter capacitor 221. The low-voltage AC power is rectified into low-voltage DC power then output.

Since the transformer 21 can be adjusted by the ratio of turns N:1 between the primary coil 211 and the secondary coil 212, the transformer 21 can effectively reduce 220V or 110V AC power down to lower voltage AC power. Afterwards, the full-bridge rectifier 22 and the filter capacitor 221 further convert the lower voltage AC power into low-voltage DC power for output. The output DC power is then used as the charging or working power of electronic devices.

Current electronic devices become lighter and more compact. However, their adapters are expensive and consists of over 10 electronic components, including a transformer. Therefore, an AC-to-DC power circuit without a transformer and with fewer components that improves reliability with lower manufacturing cost is proposed.

With reference to FIG. 6, a Taiwan utility model patent no. 533672 discloses an AC-to-DC power circuit without a transformer. The AC-to-DC power circuit has a full-bridge rectifier 31, a conduction time control circuit 32, a current switch circuit 33, and a load current limiting circuit 34.

The input terminal of the full-bridge rectifier 31 connects to an AC power supply AC/IN to rectify the AC power to DC power for output.

The conduction time control circuit 32 connects to the output terminal of the full-bridge rectifier 31 and mainly includes a voltage divider R2/R3 and a first transistor T2. The base of the first transistor T2 connects to the output terminal of the full-bridge rectifier 31 via the voltage divider R2/R3.

The current switch circuit 33 includes a second transistor T1 with a gate connected to the collector of the first transistor T2 of the conduction time control circuit 32.

The load current limiting circuit 34 connects between the ground and a node where the conduction time control circuit 32 and the current switch circuit 33 are connected together.

The current switch circuit 33 receives the output signal of the conduction time control circuit 31 and the load current limiting circuit 34, controlling the conduction and magnitude of the load current. The conduction time control circuit 32 determines the switch of the current switch circuit 33 according to the input/output (I/O) potential difference. When the potential difference is lower than a predetermined value, the load current is turned on. When the potential difference exceeds the predetermined value, the load current is shut off. The load current limiting circuit 34 limits the load current via the current switch circuit 33. When the load current exceeds the predetermined value, a signal is output to limit the load current on the current switch circuit 33. Therefore, the current switch circuit 33 provides stable low-voltage DC power.

Although the above-mentioned circuit does not need to use a transformer for stable low-voltage DC power, it has to use transistors and resistors that result in worse conversion efficiency. Therefore, it is desirable to have a better AC-to-DC power supply circuit.

### SUMMARY OF THE INVENTION

An objective of this invention is to provide an AC-to-DC power supply circuit that does not need a transformer while having better power conversion efficiency.

To achieve the above-mentioned objective, the invention includes:

an AC capacitor;

a half-wave rectifier, which connects to the AC capacitor and then to an AC power supply for rectifying the AC power into half-wave DC power;

a filter capacitor, which strides across the output terminals of the half-wave rectifier and outputs low-voltage DC power;

wherein the capacitance ratio of the filter capacitor and the AC capacitor matches the voltage ratio of the half-wave DC power and the low-voltage DC power of the filter capacitor.

The invention adjusts the capacitance ratio of the AC capacitor and the filter capacitor to convert AC power into DC power with a lower voltage. Thus, the filter capacitor can output low-voltage DC power. Not only does the invention need no transformer, it also involves fewer electronic devices for power conversion. It is therefore suitable for small electronic devices and is cheaper in manufacturing cost.

Another objective of the invention is to provide an AC-to-DC power supply circuit that has stable voltage output. The node between the filter capacitor and the half-wave rectifier is further connected to the anode of an output diode. The cathode of the output diode is connected to an energy-storing capacitor, which functions as the output terminal of the AC-to-DC power supply circuit. When the energy-storing capacitor is connected with a DC load, the use of the output diode prevents the electrical current from going back to the AC power and resulting in unstable power conversion.

### BRIEF DESCRIPTION OF THE DRAWINGS

FIG. 1 is the circuit diagram of a first embodiment of the invention;

FIG. 2 is the circuit diagram of a second embodiment of the invention;

FIG. 3 is the circuit diagram of a third embodiment of the invention;

FIG. 4 is the circuit diagram of a fourth embodiment of the invention;

FIG. 5 is the circuit diagram of a conventional AC-to-DC power supply circuit; and

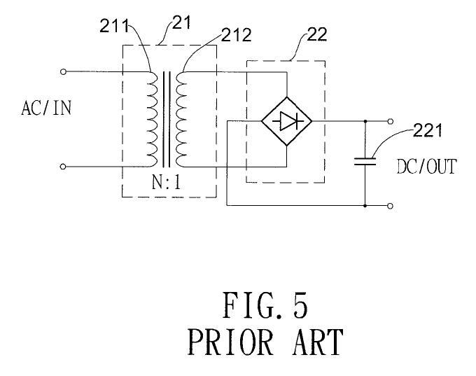

FIG. 6 is a circuit diagram of a conventional AC-to-DC power circuit.

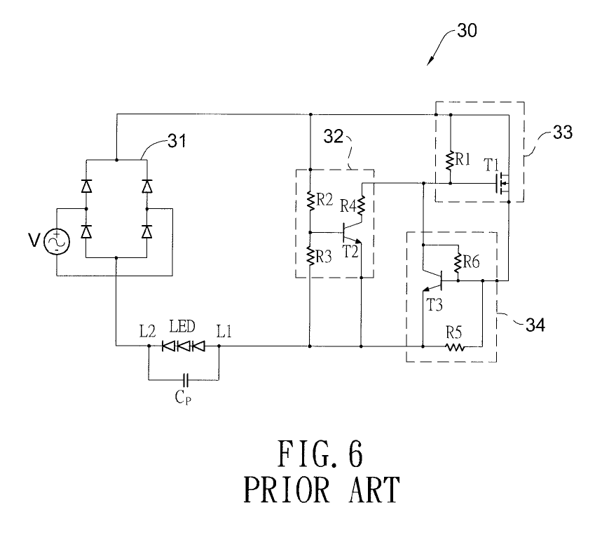

### DETAILED DESCRIPTION OF THE PREFERRED EMBODIMENT

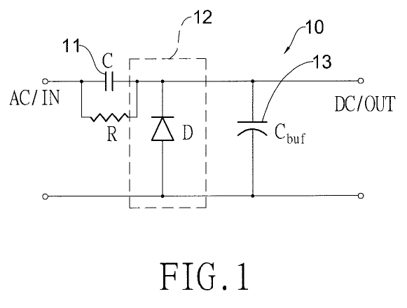

FIG. 1 is a circuit diagram of the disclosed AC-to-DC power supply circuit 10 according to a preferred embodiment and comprises an AC capacitor 11, a half-wave rectifier 12, and a filter capacitor 13.

The AC capacitor 11 in this embodiment is connected in parallel with a discharging resistor R.

The half-wave rectifier 12 is connected to the AC capacitor 11 and indirectly connected to an AC power supply AC/IN through the AC capacitor 11, converting the AC power into half-wave DC power. In this embodiment, the half-wave rectifier 12 is a single diode D having an anode and a cathode. The anode of the diode D is connected via the AC capacitor 11 to one end of the AC power supply AC/IN. The cathode of the diode D is connected to the other end of the AC power supply AC/IN.

The filter capacitor 13 is connected across the output terminals of the half-wave rectifier 12 and converts the half-wave DC power output into low-voltage DC power. The capacitance ratio of the filter capacitor 13 to the AC capacitor 11 matches with the voltage ratio of the half-wave DC power to the low-voltage DC power from the filter capacitor 13. In this embodiment, the filter capacitor 13 is an electrolyte capacitor.

The invention adjusts the capacitance ratio of the AC capacitor 11 to the filter capacitor 13 so as to effectively convert the AC power to the low-voltage DC power.

Taking the AC power supply AC/IN is a 110V AC power supply as an example and using a 23.5 uF AC capacitor and a 330 uF filter capacitor, the capacitance ratio is 1:14. Since the invention is connected to the 110V AC power, the half-wave DC voltage output by the half-wave rectifier 12 is about 155V Through an equivalent voltage divider composed of the AC capacitor 11 and the filter capacitor 13, the 155V voltage is reduced to 10V. Therefore, the invention can indeed convert the AC power to low-voltage DC power, using the above-mentioned simple circuit.

The AC capacitor 11 can be further connected in parallel with a discharging resistor R. When the AC power is interrupted, the voltage stored in the AC capacitor 11 can quickly discharge via the discharging resistor R, 9 preventing the user from being electrical shocked.

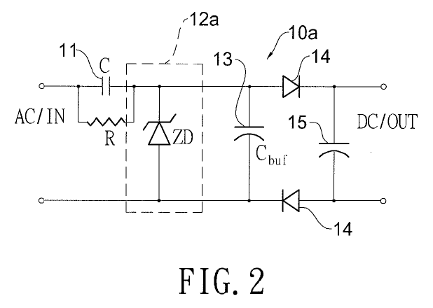

With reference to FIG. 2, a second embodiment of the AC-to-DC power supply circuit 10a is shown. One difference from the first embodiment is that the half-wave rectifier 12a is a Zener diode ZD. The anode of the Zener diode ZD is connected via the AC capacitor 11 to one end of the AC power supply AC/IN. The cathode of the Zener diode ZD is connected to the other end of the AC power supply AC/IN. Moreover, this embodiment further comprises at least one output diode 14 having an anode connected to the node where the filter capacitor and the half-wave rectifier 12 are connected, and one energy-storing capacitor 15.

This embodiment uses two output diodes 14 connected in opposite direction, wherein the first diode D has an anode connected to the node where the filter capacitor 13 and the half-wave rectifier 12 are connected together. The second diode has the cathode connected to one end of the AC power supply AC/IN. The energy-storing capacitor 15 is connected between the cathode of the first output diode 14 and the anode of the second output diode output 14. The energy-storing capacitor 15 is the output terminal of the AC-to-DC power supply circuit 10 in this embodiment.

When the energy-storing capacitor 15 is connected to a DC load, the output diodes 14 prevent the electrical current from flowing back to the AC power and resulting in unstable power conversion. Thus, the embodiment can 6 provide a stable voltage output.

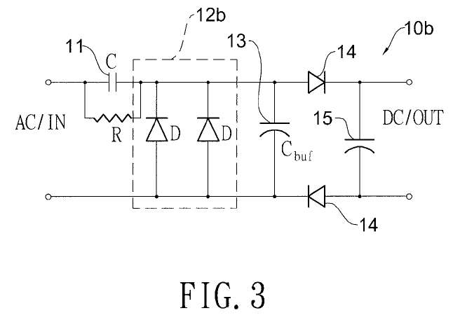

With reference to FIG. 3, a third embodiment of the disclosed AC-to-DC power supply circuit 10b is shown. In comparison with the first embodiment, the half-wave rectifier 12c is implemented as several diodes D connected in parallel. In this embodiment, two diodes D are connected in parallel. The anodes of the two diodes D are connected to one end of the AC capacitor 11. The cathodes of the two diodes D are connected to the other end of the AC power. Besides, the more than two diodes D can be connected in series as well.

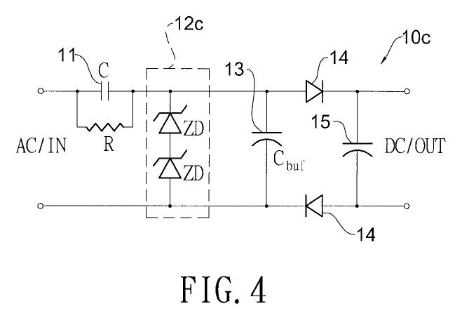

With reference to FIG. 4, a fourth embodiment of the AC-to-DC power supply circuit 10d is shown. In comparison with the first embodiment, the half-wave rectifier 12c is implemented as several Zener diodes ZD connected in series. This embodiment uses two Zener diodes ZD connected in series. The anode of one Zener diode ZD is connects via the AC capacitor 11 to one end of the AC power supply AC/IN. The cathode of the other Zener diode ZD is connected to the other end of the AC power supply AC/IN. Besides, more than two Zener diodes ZD can be connected in parallel as well.

According to the above description, not only does the invention need no use of transformer, it also accomplishes power conversion with fewer electronic devices. This is particular suitable for small electronic devices and reduces the production cost.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An AC-to-DC power supply circuit, comprising:
an AC capacitor;
a half-wave rectifier connected to the AC capacitor for the connection of an AC power supply, converting the AC power and outputting half-wave DC power; and
a filter capacitor connected to the output terminals of the half-wave rectifier and converting the half-wave DC power into low-voltage DC power;
wherein the capacitance ratio of the filter capacitor to the AC capacitor matches with the voltage ratio of the half-wave DC power to the low-voltage DC power of the filter capacitor.

2. The AC-to-DC power supply circuit as claimed in claim 1 further comprising:
an output diode having an anode connected to a node where the filter capacitor and the half-wave rectifier are connected; and
an energy-storing capacitor connected between a cathode of the output diode and a ground.

3. The AC-to-DC power supply circuit as claimed in claim 1 further comprising:
a first and a second output diodes connected in opposite directions, wherein the first output diode has an anode connected to a node where the filter capacitor and the half-wave rectifier are connected, and the second output diode has a cathode connected to one end of the AC power supply; and
an energy-storing capacitor connected between a cathode of the first output diode and an anode of the second output diode.

4. The AC-to-DC power supply circuit as claimed in claim 1, wherein the half-wave rectifier is a single diode whose anode adapted to connect to one end of the AC power supply through the AC capacitor and whose cathode adapted to connect to the other end of the AC power supply.

5. The AC-to-DC power supply circuit as claimed in claim 2, wherein the half-wave rectifier is a single diode whose anode adapted to connect to one end of the AC power supply through the AC capacitor and whose cathode adapted to connect to the other end of the AC power supply.

6. The AC-to-DC power supply circuit as claimed in claim 3, wherein the half-wave rectifier is a single diode whose anode adapted to connect to one end of the AC power supply through the AC capacitor and whose cathode adapted to connect to the other end of the AC power supply.

7. The AC-to-DC power supply circuit as claimed in claim 1, wherein the half-wave rectifier is a single Zener diode whose anode adapted to connect to one end of the AC power supply through the AC capacitor and whose cathode adapted to connect to the other end of the AC power supply.

8. The AC-to-DC power supply circuit as claimed in claim 2, wherein the half-wave rectifier is a single Zener diode whose anode adapted to connect to one end of the AC power supply through the AC capacitor and whose cathode adapted to connect to the other end of the AC power supply.

9. The AC-to-DC power supply circuit as claimed in claim 3, wherein the half-wave rectifier is a single Zener diode whose anode adapted to connect to one end of the AC power supply through the AC capacitor and whose cathode adapted to connect to the other end of the AC power supply.

10. The AC-to-DC power supply circuit as claimed in claim 1, wherein the half-wave rectifier comprises a plurality of diodes connected in parallel with their anodes connecting to one end of the AC capacitor and their cathodes adapted to connect to the other end of the AC power.

11. The AC-to-DC power supply circuit as claimed in claim 2, wherein the half-wave rectifier comprises a plurality of diodes connected in parallel with their anodes connecting to one end of the AC capacitor and their cathodes adapted to connect to the other end of the AC power.

12. The AC-to-DC power supply circuit as claimed in claim 3, wherein the half-wave rectifier comprises a plurality of diodes connected in parallel with their anodes connecting to one end of the AC capacitor and their cathodes adapted to connect to the other end of the AC power.

13. The AC-to-DC power supply circuit as claimed in claim 1, wherein the half-wave rectifier comprises a plurality of diodes connected in series, an anode of the series-connected diodes is connected to one end of the AC capacitor and a cathode of the series-connected diodes is adapted to connect to the other end of the AC power supply.

14. The AC-to-DC power supply circuit as claimed in claim 2, wherein the half-wave rectifier comprises a plurality of diodes connected in series, an anode of the series-connected diodes is connected to one end of the AC capacitor and a cathode of the series-connected diodes is adapted to connect to the other end of the AC power supply.

15. The AC-to-DC power supply circuit as claimed in claim 3, wherein the half-wave rectifier comprises a plurality of diodes connected in series, an anode of the series-connected diodes is connected to one end of the AC capacitor and a cathode of the series-connected diodes is adapted to connect to the other end of the AC power supply.

16. The AC-to-DC power supply circuit as claimed in claim 1, wherein the half-wave rectifier comprises a plurality of Zener diodes connected in parallel with their anodes connecting to one end of the AC capacitor and their cathodes adapted to connect to the other end of the AC power.

17. The AC-to-DC power supply circuit as claimed in claim 2, wherein the half-wave rectifier comprises a plurality of Zener diodes connected in parallel with their anodes connecting to one end of the AC capacitor and their cathodes adapted to connect to the other end of the AC power.

18. The AC-to-DC power supply circuit as claimed in claim 3, wherein the half-wave rectifier comprises a plurality of Zener diodes connected in parallel with their anodes connecting to one end of the AC capacitor and their cathodes adapted to connect to the other end of the AC power.

19. The AC-to-DC power supply circuit as claimed in claim 1, wherein the half-wave rectifier comprises a plurality of Zener diodes connected in series, an anode of the series-connected Zener diodes is connected to one end of the AC capacitor and a cathode of the series-connected Zener diodes is adapted to connect to the other end of the AC power.

20. The AC-to-DC power supply circuit as claimed in claim 2, wherein the half-wave rectifier comprises a plurality of Zener diodes connected in series, an anode of the series-connected Zener diodes is connected to one end of the AC capacitor and a cathode of the series-connected Zener diodes is adapted to connect to the other end of the AC power.
